(19) United States
(12) Patent Application Publication
(10) Pub. No.: US 2009/0207349 A1
(43) Pub. Date: Aug. 20, 2009

(54) LIQUID CRYSTAL PANEL PROVIDED WITH LIQUID CRYSTAL CELL HAVING MULTIGAP STRUCTURE, AND LIQUID CRYSTAL DISPLAY

(75) Inventors: Hiroyuki Yoshimi, Osaka (JP); Tadayuki Kameyama, Osaka (JP); Masatoshi Tomonaga, Osaka (JP); Masaki Hayashi, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/301,290

(22) PCT Filed: Oct. 16, 2007
(86) PCT No.: PCT/JP2007/070139

§ 371 Date: Feb. 24, 2009

(30) Foreign Application Priority Data
Oct. 30, 2006 (JP) 2006-293417
May 8, 2007 (JP) 2007-123095

(51) Int. Cl. G02F 1/1335

(52) U.S. Cl. 349/107

(57) ABSTRACT

A liquid crystal panel of the present invention comprises a liquid crystal cell, a first polarizing plate arranged on one of both sides of the liquid crystal cell, and a second polarizing plate arranged on the other side of the liquid crystal cell, wherein the liquid crystal cell comprises red, green and blue color filters, and a liquid crystal layer. The liquid crystal layer has a multigap structure satisfying the following relationship: d_{R}≧d_{G}>d_{B}. The first polarizing plate comprises a first polarizer and a first protective layer arranged on the liquid crystal cell side of the first polarizer, and in the first protective layer, the index ellipsoid thereof satisfies the following relationship: nx>ny≧nz.

In a liquid crystal display having the liquid crystal panel, the color shift thereof can be made smaller in oblique directions and display characteristics can be excellent.

### TECHNICAL FIELD

The present invention relates to a liquid crystal panel provided with a liquid crystal cell having a multigap structure, and a liquid crystal display.

### BACKGROUND ART

A liquid crystal display is an elemental device for displaying characters and images by using electrooptical characteristics of liquid crystal molecules.

The liquid crystal display has widely been spreading in portable telephones, notebook-sized personal computers, liquid crystal televisions, and the like. However, the liquid crystal display has a problem that the display exhibits excellent display characteristic in some single direction, but this screen gets dark or obscure in other directions since liquid crystal molecules having optical anisotropy are used in the display. In order to solve the above problem, plural retardation films are used in a liquid crystal display.

Hitherto, a liquid crystal cell having the so-called multigap structure has been known, wherein the thickness of a liquid crystal layer is varied, correspondingly to individual colors of a color filter (see, for example, Patent Document 1). However, the liquid crystal display using the liquid crystal cell and a polarizing plate having a conventional structure has a problem that a large color shift is generated in oblique directions.

Patent Document 1: JP-A-2006-91083

### DISCLOSURE OF THE PRESENT INVENTION

An object of the present invention is to provide a liquid crystal display wherein a large color shift is not generated in oblique directions.

The inventors of the present invention have made earnest studies to solve the above problems and, as a result, found that the above object can be attained by the following liquid crystal panel, and complete the present invention.

A liquid crystal panel of the present invention is provided with a liquid crystal cell, a first polarizing plate arranged on one of both sides of the liquid crystal cell, and a second polarizing plate arranged on the other side of the liquid crystal cell, wherein the liquid crystal cell comprises red, green and blue color filters, and a liquid crystal layer, the liquid crystal layer has a multigap structure satisfying the following relationship: d_{R}≧d_{G}>d_{B}, the first polarizing plate comprises a first polarizer and a first protective layer arranged on the liquid crystal cell side of the first polarizer, and the index ellipsoid of the first protective layer satisfies the following relationship: nx>ny≧nz. Here, d_{R}, d_{G} and d_{B} represent the thicknesses of the liquid crystal layer which correspond to the red color filter, the green color filter, and the blue color filter, respectively.

The liquid crystal panel of the present invention is provided with the liquid crystal cell having the multigap structure satisfying the relationship of d_{R}≧d_{G}>d_{B}, and the polarizing plate having the protective layer of having the index ellipsoid satisfying the relationship of nx>ny≧nz. In the liquid crystal display having this liquid crystal panel, the color shift thereof can be made smaller in oblique directions than liquid crystal displays having a conventional liquid crystal panel.

In a preferred embodiment of the liquid crystal panel, the above multigap structure is formed by making the thicknesses of the red, green, and blue color filters different from each other.

In a preferred embodiment of the liquid crystal panel, the above liquid crystal layer comprises liquid crystal molecules aligned to homeotropic alignment when no voltage is applied thereto, and further the retardation value in the thickness direction (Rth_{LC}[550]) of the liquid crystal layer at a wavelength of 550 nm is larger than the retardation value in the thickness direction (Rth_{LC}[450]) of the liquid crystal layer at a wavelength of 450 nm.

In a preferred embodiment of the liquid crystal panel, the liquid crystal layer comprises liquid crystal molecules aligned to homogeneous alignment when no voltage is applied thereto, and further the in-plane retardation value (Re_{LC}[550]) of the liquid crystal layer at a wavelength of 550 nm is larger than the in-plane retardation value (Re_{LC}[450]) of the liquid crystal layer at a wavelength of 450 nm.

In a preferred embodiment of the liquid crystal panel, the slow axis direction of the first protective layer is substantially perpendicular to the absorption axis direction of the first polarizing plate.

In a preferred embodiment of the liquid crystal panel, the in-plane retardation value (Re₁[550]) of the first protective layer at a wavelength of 550 nm is from 20 to 200 nm.

In a preferred embodiment of the liquid crystal panel, the first protective layer is a retardation film (A) containing a norbornene-based resin.

According to another aspect of the present invention, a liquid crystal display is provided. The liquid crystal display comprises the above-mentioned liquid crystal panel.

### BRIEF DESCRIPTION OF THE DRAWINGS

FIG. 1 is a schematic sectional view of a liquid crystal panel according to a preferred embodiment of the present invention.

FIGS. 2A, 2B, 2C, and 2D are each a schematic sectional view of a liquid crystal panel illustrating a positional relationship between individual constituting members according to a preferred embodiment.

FIGS. 3A, 3B, and 3C are each a schematic sectional view of a liquid crystal cell according to a preferred embodiment.

FIG. 4 is a schematic sectional view of a liquid crystal display according to a preferred embodiment of the present invention.

FIG. 5 is a schematic perspective view of a liquid crystal panel according to an example.

FIG. 6 is a graph showing the color shift amount of the/a liquid crystal panel according to each of Example and Comparative Example.

### BEST MODE FOR CARRYING OUT THE PRESENT INVENTION

### Definition of Terms and Symbols

The definition of each term and symbol in the present specification are as follow.

(1) Refractive index (nx, ny, nz):

“nx” is a refractive index in a direction having a maximum in-plane refractive index (namely, a slow axis direction). “ny” is a refractive index in a direction perpendicular to the slow axis in the plane (namely, a fast axis direction). “nz” is a refractive index in a thickness direction.

(2) In-plane retardation value:

An in-plane retardation value (Re[λ]) is an in-plane retardation value of a sample at 23° C. and a wavelength of λ (nm), and a value calculated from an expression: Re[λ]=(nx−ny)×d, when a thickness of the sample is d (nm).

(3) Retardation value in thickness direction:

A retardation value in a thickness direction (Rth[λ]) means a retardation value in the thickness direction of a sample at 23° C. and a wavelength of λ (nm). The Rth[λ] is a value calculated from an expression: Re[λ]=(nx−nz)×d, when a thickness of the sample is d (nm).

(4) Birefringence index in thickness direction:

A birefringence index in a thickness direction (Δn_{xy}[λ]) is a value calculated from an expression: Rth[λ]/d. Here, the Rth[λ] is a retardation value in a thickness direction, and “d” represents a thickness (nm).

### (5) Nz Coefficient:

An Nz coefficient is a value calculated from an expression: Rth[550]/Re [550].

(6) When there is a description “nx=ny” or “ny=nz” in the present specification, this includes the case where both sides of each expression are perfectly equal to each other and the case where both sides of each expression is substantially equal to each other. Therefore, even if, for example, there is the description “nx=ny”, this includes the case where the Re [550] is less than 10 nm.
(7) In the present specification, a description “substantially perpendicular” includes a case where an angle formed by two optical axes is 90±2° and preferably 90±1°, and a description “substantially parallel” includes a case where an angle formed by two optical axes is 0±2° and preferably 0±1°.
(8) In the present specification, for example, a subscript “LC” represents a liquid crystal layer, and subscripts “1” and “2” represent a first protective layer and a second protective layer, respectively.

### A. Outline of Liquid Crystal Panel

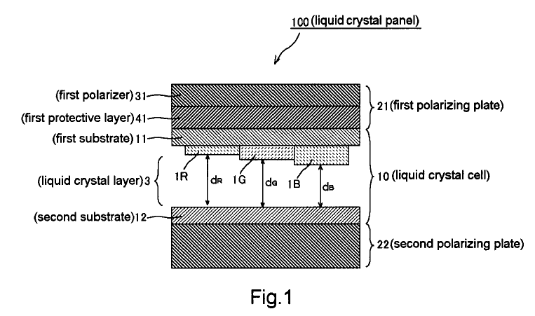

FIG. 1 is a schematic sectional view of a liquid crystal panel according to a preferred embodiment of the present invention. This liquid crystal panel 100 is provided with a liquid crystal cell 10, a first polarizing plate 21 arranged on one of both sides of the liquid crystal cell 10, and a second polarizing plate 22 arranged on the other side of the liquid crystal cell 10. The liquid crystal cell 10 comprises red, green and blue color filters (1R, 1G and 1B represent the red color filter, the green filter, and the blue filter, respectively; the same rule will be correspondingly applied to the following), and a liquid crystal layer 3. The liquid crystal layer 3 has a multigap structure satisfying the following relationship: d_{R}≧d_{G}>d_{B}. Here, the d_{R}, d_{G} and d_{B} represent the thicknesses of the liquid crystal layer which correspond to the red color filter, the green color filter, and the blue color filter, respectively. The first polarizing plate 21 comprises a first polarizer 31 and a first protective layer 41 arranged on the liquid crystal cell 10 side of the first polarizer 31. The index ellipsoid of the first protective layer 41 satisfies the following relationship: nx>ny≧nz. Here, the first polarizing plate 21 may be arranged on the viewing side, or may be arranged on the side reverse to the viewing side. In each of the figures, the upper side of any illustrated liquid crystal cell is the viewing side.

In this liquid crystal panel, the liquid crystal layer has the above-mentioned multigap structure; therefore, the liquid crystal panel has different retardation values in accordance with the thickness of the liquid crystal layer corresponding to the individual color filters. The liquid crystal layer exhibits, as a whole thereof, the so-called reverse wavelength dispersion characteristic, that is, a property that the retardation value becomes larger at a larger wavelength.

When this liquid crystal layer, which exhibits reverse wavelength dispersion characteristic, is combined with the polarizing plates, which will be detailed later, the intensity of light emitted to the viewing side of the liquid crystal panel becomes constant regardless of the wavelength thereof. For this reason, a liquid crystal display can be obtained wherein only a smaller color shift is generated in oblique directions than in a conventional liquid crystal display. Hereinafter, each of the constituting members of the liquid crystal panel of the present invention will be described in detail; however, the present invention is not limited only to the following specific embodiments.

### B. Liquid Crystal Cell

The liquid crystal cell used in the present invention is arranged between a first polarizing plate and a second polarizing plate. Referring to FIG. 1, the liquid crystal cell 10 comprises the red, green and blue color filters (1R, 1G and 1B), and the liquid crystal layer 3. The liquid crystal layer 3 is sandwiched between a first substrate 11 and a second substrate 12. The color filters are preferably formed on the first substrate 11. TFT elements (not illustrated) for controlling the electrooptical property of the liquid crystal, scanning lines for giving gate signals to active elements, and signal lines (not illustrated) for giving source signals to the active elements, are preferably provided on the second substrate 12.

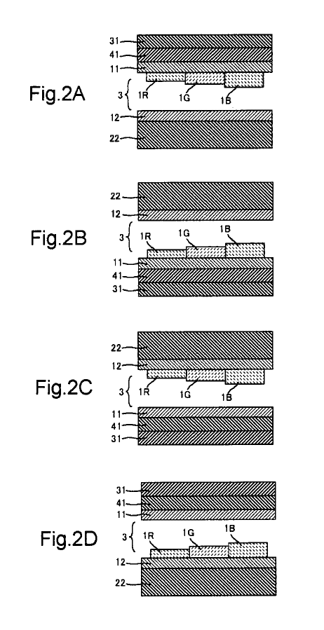

In the present invention, the color filters may be formed on any one of the first substrate side and the second substrate side. FIGS. 2A, 2B, 2C, and 2D are each a schematic sectional view of a liquid crystal panel which illustrates a positional relationship between individual constituting members according to a preferred embodiment. In a liquid crystal panel illustrated in FIG. 2A, color filters (1R, 1G and 1B) are formed on the side of a first substrate 11, and a first polarizer 31 and a first protective layer 41 (namely, a first polarizing plate) are arranged on the viewing side of the liquid crystal cell. A second polarizing plate 22 is arranged on the side reverse to the viewing side of the liquid crystal cell. A liquid crystal panel illustrated in FIG. 2B is a panel obtained by turning the liquid crystal panel illustrated in FIG. 2A upside down. In a liquid crystal panel illustrated in FIG. 2C, color filters (1R, 1G and 1B) are formed on the side of a second substrate 12, and a first polarizer 31 and a first protective layer 41 (namely, a first polarizing plate) are arranged on the side reverse to the viewing side of the liquid crystal cell. A second polarizing plate 22 is arranged on the viewing side of the liquid crystal cell. A liquid crystal panel illustrated in FIG. 2D is a panel obtained by turning the liquid crystal panel illustrated in FIG. 2C upside down.

As the color filter used in the present invention, any appropriate color filter having three primary color filter of red, green and blue, may be used. The color filter may further have, for example, a filter in a different color such as deep red. The red filter exhibits a maximum transmittance preferably in the wavelength range of from 400 to 480 nm. The green filter exhibits a maximum transmittance preferably in the wavelength range of from 520 to 580 nm. The blue filter exhibits a maximum transmittance preferably in the wavelength range of from 590 to 780 nm. The preferred maximum transmittance of each of the color filters is 80% or more.

As a thickness of the color filter, an appropriate and arbitrary thickness may be selected. The thickness of the color filter is preferably from 0.5 to 4 μm, and more preferably from 0.8 to 3.5 μm. The pixel pattern of the color filter may be selected from any pattern such as a stripe-type, mosaic-type, triangular-type, block-type, or the like.

In the pixel region where the color filter is formed, a black matrix arranged in boundary regions between the individual color filters is optionally provided. Alternatively, in the pixel region where the color filter is formed, a protecting layer formed to cover the color filter is optionally arranged (a transparent electroconductive film may be formed on this protecting layer).

The color material from which the color filter is formed is not particularly limited and, for example, a dye or pigment may be used. The dye-based color filter has features of being excellent in transparency or contrast and rich in spectroscopic variation. The pigment-based color filter has features of being excellent in heat resistance and light resistance. As the method for forming the color filter, for example, photolithography, etching, printing, electrodeposition, ink-jetting, vapor deposition, or the like may be used.

The color material, which forms the color filter, is preferably a pigment. The pigment-based color filter may be formed from a colored resin wherein a pigment is dispersed in a binder resin such as acrylic resin or polyimide. Examples of the pigment include the following (Color Index (Generic name)): Pigment Red 177 (crimson lake), Pigment Red 168, Pigment Green 7 (phthalocyanine green), Pigment Green 36, Pigment Blue 15 (phthalocyanine blue), Pigment Blue 6, and Pigment Yellow 83 (azo-based yellow). About the pigments, plural colors may be used in a mixture form in order to adjust the color.

In connection with the state of the dispersed pigment, the average particle diameter of secondary particles thereof is preferably 0.2 μm or less, more preferably 0.1 μm or less. The secondary particles are each an aggregate wherein fine particles of the pigment (primary particles) are bonded to each other. By use of a pigment in such a dispersion state, a color filter high in transmittance and low in depolarizability can be formed.

The liquid crystal layer used in the present invention has a multigap structure, and the thicknesses thereof which correspond to the individual color filters satisfy the following relationship: d_{R}≧d_{G}>d_{B}. Here, the d_{R}, d_{G} and d_{B} represent the thicknesses of the liquid crystal layer which correspond to the red color filter, the green color filter, and the blue color filter, respectively. The thicknesses of the liquid crystal layer which correspond to the individual color filters most preferably satisfy the following relationship: d_{R}>d_{G}>d_{B}. However, even if the relationship of d_{R}=d_{G} is satisfied, leakage of light from the blue region in the liquid crystal panel, where a large effect is produced, can be decreased when the relationship of d_{G}>d_{B} is satisfied. As a result, relatively good display characteristic can be obtained.

The expressions: (d_{R}−d_{G}) and (d_{G}−d_{B}) are preferably from 0.2 to 2 μm, more preferably from 0.2 to 1 μm. Preferably, d_{R} is from 2.9 to 4.4 μm, d_{G} is from 2.7 to 4.2 μm, and d_{B} is from 2.5 to 4.0 μm.

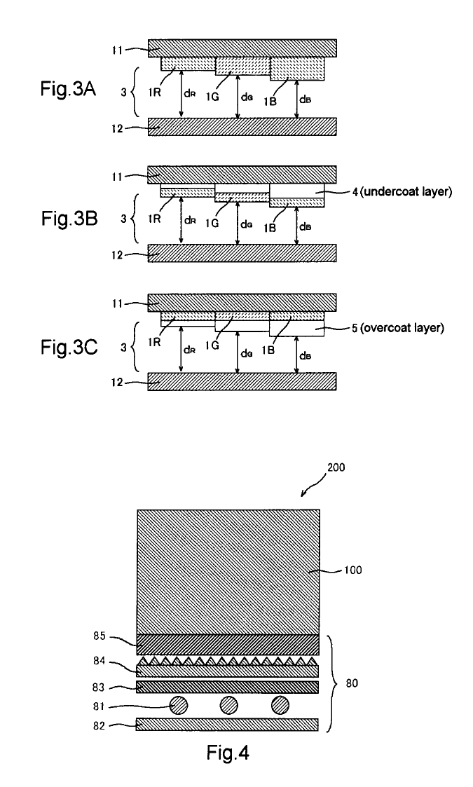

The method for forming the multigap structure may be selected from any appropriate method. FIGS. 3A, 3B, and 3C are each a schematic sectional view of a liquid crystal cell according to a preferred embodiment. According to one example of the method, the multigap structure is formed by making the thicknesses of the red, green, and blue color filters (1R, 1G and 1B) different from each other, as illustrated in FIG. 3A. At this time, about the thicknesses of the individual color filters, it is preferred that the color filter in blue, out of the three primary colors, is the thickest, the green filter is the second thickest and the red color filter is the thinnest. For example, in a case where photolithography or etching is selected to form the color filters, the thicknesses of the individual color filters can be increased or decreased in accordance with the coating amount of the colored resins. In a case where electrodeposition or vapor deposition is selected to form the color filters, the thicknesses of the individual color filters can be adjusted in accordance with the period for the immersion into an electrodepositing solution, or the period for the vapor deposition.

According to another example of the method, as illustrated in FIG. 3B, the multigap structure is formed by providing an undercoat layer 4 on the first substrate 11 side of the individual color filters (1R, 1G and 1B), and then making the thicknesses of the undercoat layer corresponding to the individual colors different from each other. When the thicknesses of the individual color filters (1R, 1G and 1B) are, for example, equal to each other, the thickness of the undercoat layer corresponding to the red color filter is made thin, that of the undercoat layer corresponding to the green color filter is made middle, and that of the undercoat layer corresponding to the blue color filter is made thick. When such an undercoat layer is formed, a multigap structure satisfying the relationship of d_{R}>d_{G}>d_{B} can be formed.

According to still another example of the method, as illustrated in FIG. 3C, the multigap structure is formed by providing an overcoat layer 5 on the liquid crystal layer 3 side of the individual color filters (1R, 1G and 1B), and then making the thicknesses of the overcoat layer corresponding to the individual colors different from each other. At this time, the overcoat layer may also function as a protecting layer for the color filters.

When the thicknesses of the individual color filters (1R, 1G and 1B) are, for example, equal to each other, the thickness of the overcoat layer corresponding to the red color filter is made thin, that of the overcoat layer corresponding to the green color filter is made middle, and that of the overcoat layer corresponding to the blue color filter is made thick. When such an overcoat layer is formed, a multigap structure satisfying the relationship of d_{R}>d_{G}>d_{B} can be formed.

In the illustrated examples, the thicknesses of the individual color filters are equal to each other; however, the thicknesses may be different from each other in accordance with the colors. In this case also, the multigap structure can be obtained by adjusting the thickness of the undercoat layer or the overcoat layer appropriately. The liquid crystal cell used in the present invention may have both of the undercoat layer and the overcoat layer. Alternatively, the liquid crystal cell used in the present invention may have the undercoat layer and/or the overcoat layer only on the color filter(s) in one or two out of the colors of red, green and blue.

The material for forming the undercoat layer and the overcoat layer is preferably a material high in transparency and excellent in heat resistance. Examples of the material include a polyimide-based resin; ultraviolet curable resins such as an acrylic and epoxy resin; and the like.

The above-mentioned liquid crystal layer preferably comprises liquid crystal molecules aligned to homeotropic or homogeneous alignment when no voltage is applied thereto. In the present specification, the description “homeotropic alignment” means that the alignment vector of liquid crystal molecules is aligned in vertical (normal direction) to planes of the substrate by a result of interaction between the substrate subjected to orientation treatment and the liquid crystal molecule. The “homogeneous alignment” means that the alignment vector of liquid crystal molecules is aligned in parallel to planes of the substrate by a result of interaction between the substrate subjected to orientation treatment and the liquid crystal molecule. The homeotropic alignment and the homogeneous alignment each also include an alignment of a case where the liquid crystal molecules have a pretilt.

In a case where the liquid crystal layer comprises liquid crystal molecules aligned to homeotropic alignment when no voltage is applied thereto, the liquid crystal layer preferably has an index ellipsoid satisfying the following relationship: nz>nx=ny. Examples of a drive mode of the liquid crystal cell having the index ellipsoid satisfying the relationship of nz>nx=ny include a vertical alignment (VA) mode. In a case where the liquid crystal layer comprises liquid crystal molecules aligned to homogeneous alignment when no voltage is applied thereto, the liquid crystal layer preferably has an index ellipsoid satisfying the following relationship of nx>ny=nz. Examples of a drive mode of the liquid crystal cell having the index ellipsoid satisfying the relationship of nx>ny=nz include a in-plane switching (IPS) mode, fringe field switching (FFS) mode, or the like.

The liquid crystal material (liquid crystal molecules) used in the liquid crystal layer may be selected from any appropriate material. About the liquid crystal material, two or more liquid crystal compounds are usually used in a mixture form. The material preferably includes a fluorine-containing liquid crystal compound since the material can be expected to have a low viscosity and a high-speed responsibility. The liquid crystal material may be a material the dielectric anisotropy (Δ∈) of which is positive or negative. A liquid crystal material having a positive Δ∈ is used preferably in a liquid crystal cell in an IPS mode, and a liquid crystal material having a negative Δ∈ is used preferably in a liquid crystal cell in a VA mode. The birefringence index (Δn[550]) of the liquid crystal material at a wavelength of 550 nm is preferably from 0.06 to 0.15.

In a case where the liquid crystal layer comprises liquid crystal molecules aligned to homeotropic alignment when no voltage is applied thereto, the retardation value in the thickness direction of the liquid crystal layer (Rth_{LC}[550]) is preferably from −250 to −400 nm, more preferably from −270 to −350 nm.

In a case where the liquid crystal layer comprises liquid crystal molecules aligned to homogeneous alignment when no voltage is applied thereto, the in-plane retardation value (Re_{LC}[550]) is preferably from 250 to 400 nm, more preferably from 270 to 350 nm.

In a case where the liquid crystal layer comprises liquid crystal molecules aligned to homeotropic alignment when no voltage is applied thereto, the Rth_{LC}[550] of the liquid crystal layer is larger than the Rth_{LC}[450] (namely, the liquid crystal layer exhibits reverse wavelength dispersion characteristic). In this case, the wavelength dispersion value (Dth_{LC}) of the retardation value in the thickness direction of the liquid crystal layer is preferably 0.7 or more and less than 1, more preferably from 0.8 to 0.95. In a case where the liquid crystal layer comprises liquid crystal molecules aligned to homogeneous alignment when no voltage is applied thereto, the Re_{LC}[550] of the liquid crystal layer is larger than the Re_{LC}[450] (namely, the liquid crystal layer exhibits reverse wavelength dispersion characteristic). In this case, the wavelength dispersion value (D_{LC}) of the in-plane retardation value of the liquid crystal layer is preferably 0.7 or more and less than 1, more preferably from 0.8 to 0.95. In addition, each of the wavelength dispersion values can be calculated from the following expressions:

Dth_{LC}=Rth_{LC}[450]/Rth_{LC}[550]

D_{LC}=Re_{LC}[450]/Re_{LC}[550]

The liquid crystal layer exhibiting reverse wavelength dispersion characteristic as described above makes it possible to reduce light leakage from the blue region, which have hitherto caused deterioration in display characteristic. Therefore, in the case of using the liquid crystal layer having reverse wavelength dispersion characteristic, a liquid crystal display wherein only a far smaller color shift is generated in oblique directions can be obtained.

### C. Polarizing Plates

The first polarizing plate used in the present invention is arranged on one of both sides of the liquid crystal cell, and the second polarizing plate is arranged on the other side of the liquid crystal cell. Preferably, the first polarizing plate is arranged on the viewing side of the liquid crystal cell, and the second polarizing plate is arranged on the other side of the liquid crystal cell. The first and second polarizing plates are preferably arranged to make the absorption axis direction of the first polarizing plate substantially perpendicular to the absorption axis direction of the second polarizing plate.

The first and second polarizing plates are each preferably adhered onto a surface of the liquid crystal cell through an adhesive layer.

In the present specification, the “adhesive layer” means a layer that adheres both surfaces of neighboring members to integrate these members with each other by practically sufficient adhesive force in a practically adequate adhering time. Examples of materials forming the adhesive layer include adhesives and anchor coating agents. The above adhesive layer may have a multiplayer structure in which an anchor coat layer is formed on the surface of a body and an adhesive layer is formed on the anchor coat layer. In addition, the adhesive layer may be a thin layer as is not discernible with the naked eye (also referred to as a hairline).

The first polarizing plate comprises a first polarizer, and a first protective layer on the liquid-crystal-cell-arranged side of the first polarizer. The first protective layer is preferably adhered onto the first polarizer through an adhesive layer. Preferably, the first protective layer and the first polarizer are arranged to make the slow axis direction of the first protective layer substantially perpendicular to the absorption axis direction of the first polarizer.

The thickness of the first polarizing plate is preferably from 40 to 500 μm. The transmittance of the first polarizing plate is preferably from 38 to 45%. The polarization degree of the first polarizing plate is preferably 98% or more.

The polarization degree of the polarizing plate is measured by using a spectrophotometer (trade name: “DOT-3”, manufactured by Murakami Color Research Laboratory). Specifically, the parallel transmittance (H₀) and orthogonal transmittance (H₉₀) of the polarizing plate are measured to find the polarization degree from the following expression: Polarization Degree (%)={(H₀−H₉₀)/(H₀+H₉₀)}^{1/2}×100. The parallel transmittance (H₀) is a value of the transmittance of a parallel type laminate polarizing plate produced by overlapping two of the same polarizing plates on each other such that the absorption axes of these polarizing plates are parallel to each other. Also, the orthogonal transmittance (H₉₀) is a value of the transmittance of an orthogonal type laminate polarizing plate produced by overlapping two of the same polarizing plates on each other such that the absorption axes of these polarizing plates are perpendicular to each other. These transmittances are Y values of tristimulus value based on the two-degree field on the code of JIS Z 8701-1995.

In the present specification, the “polarizer” means an optical member for converting natural light or polarized light to linearly polarized light. As the polarizer, any appropriate polarizer may be selected. Preferably, the polarizer has a function of separating incident light to two polarized light components perpendicular to each other, transmitting one of the polarized light components, and absorbing, reflecting and/or scattering the other. The thickness of the first polarizer is preferably from 10 to 100 μm.

The first polarizer is preferably made mainly of a polyvinyl-alcohol-based resin containing iodine. The first polarizer can be obtained by drawing a polymeric film made mainly of a polyvinyl-alcohol-based resin containing iodine 5 to 6.2 times longer than the original length. The content by percentage of iodine in the first polarizer is preferably from 1 to 3% by weight.

The index ellipsoid of the first protective layer satisfies a relationship of nx>ny≧nz. In the present specification, the description “nx>ny≧nz” means the relationship of nx>ny=nz (also referred to as positive uniaxially) or the relationship of nx>ny>nz (also referred to as negative biaxially). The protective layer can prevent the polarizer from contracting or expanding, so as to make the mechanical strength of the polarizer high. Additionally, the protective layer may be combined with the above-mentioned liquid crystal cell, which has a multigap structure, thereby making it possible to yield a liquid crystal display wherein a large color shift is not generated in oblique directions.

The first protective layer may be a single layer, or may be a laminate composed of plural layers. The thickness of the first protective layer is preferably from 20 to 200 μm. The transmittance (T₁[550]) of the first protective layer at a wavelength of 550 nm is preferably 90% or more.

The Re₁[550] of the first protective layer may be appropriately set in accordance with the alignment state of the liquid crystal molecules when no voltage is applied thereto, or a purpose. The Re₁[550] is 10 nm or more, preferably from 20 to 200 nm.

In a case where the liquid crystal layer comprises liquid crystal molecules aligned to homeotropic alignment when no voltage is applied thereto, the Re₁[550] of the first protective layer is preferably from 70 to 200 nm, more preferably from 70 to 160 nm. A liquid crystal display having a high contrast ratio in oblique directions can be obtained by use of the first protective layer having the Re₁[550] in the above-mentioned range in the liquid crystal cell comprising liquid crystal molecules aligned to homeotropic alignment.

In a case where the liquid crystal layer comprises liquid crystal molecules aligned to homogeneous alignment when no voltage is applied thereto, the in-plane retardation of the first protective layer at a wavelength of λ (Re₁[λ]) is set to turn the total of the Re₁[λ] and the Re_{LC}[λ] of the liquid crystal layer to about ¾λ(about 0.75λ=Re₁[λ]+Re_{LC}[λ]). At a wavelength of, for example, 550 nm, the Re₁[λ] is set to turn the total of the Re₁[550] and the Re_{LC}[550] to about 413 nm. This Re_{SUM}[550] (Re_{SUM}[550]=Re₁[550]+Re_{LC}[550]) is preferably from 350 to 470 nm, more preferably from 370 to 450 nm. The Re₁[550] is preferably from 20 to 150 nm, more preferably from 20 to 100 nm. A liquid crystal display having a high contrast ratio in oblique directions can be obtained by use of the first protective layer having the Re₁[550] in the above-mentioned range in the liquid crystal cell comprising liquid crystal molecules aligned to homogeneous alignment.

The wavelength dispersion value (D₁) of the in-plane retardation of the first protective layer is preferably 0.7 or more and 1 or less, more preferably from 0.8 to 0.95. In the same manner as in the above-mentioned liquid crystal cell, a liquid crystal display wherein only a far smaller color shift is generated in oblique directions can be obtained by using, as the first protective layer, a protective layer having a larger in-plane retardation value at a wavelength of 550 nm (Re₁[550]) than the in-plane retardation value at a wavelength of 450 nm (Re₁[450]) thereof (namely, a protective layer exhibiting reverse wavelength dispersion characteristic).

The wavelength dispersion value of the protective layer is calculated out from the following expression:

D₁=Re₁[450]/Re₁[550]

The Rth₁[550] of the first protective layer may be appropriately set. When the index ellipsoid of the first protective layer satisfies the relationship of nx>ny=nz, the Re₁[550] is substantially equal to the Rth₁[550]. In this case, the first protective layer preferably satisfies the following expression: |Rth₁[550]−Re₁[550]|<10 nm

When the index ellipsoid of the first protective layer satisfies the relationship of nx>ny>nz, the Rth₁[550] is larger than the Re₁[550]. In this case, the difference between the Rth₁[550] and the Re₁[550] (Rth₁[550]−Re₁[550]) is preferably from 10 to 100 nm. By use of this first protective layer, a liquid crystal display having a high contrast ratio in oblique directions can be obtained.

The Nz coefficient of the first protective layer may be appropriately set. When the index ellipsoid of the first protective layer satisfies the relationship of nx>ny=nz, the Nz coefficient is preferably more than 0.9 and less than 1.1. When the index ellipsoid of the first protective layer satisfies the relationship of nx>ny>nz, the Nz coefficient is preferably from 1.1 to 3.0, more preferably from 1.1 to 2.0. By use of the first protective layer having an Nz coefficient in the above-mentioned range, a liquid crystal display having a high contrast ratio in oblique directions can be obtained.

The material for forming the first protective layer may be selected from any appropriate material as far as the material satisfies the relationship of nx>ny≧nz. As the material for forming the first protective layer, for example, a retardation film containing a thermoplastic resin such as a norbornene-based resin, a polycarbonate-based resin, a cellulose-based resin, a polyester-based resin, or the like may be used. The retardation film contains the thermoplastic resin preferably in an amount of from 60 to 100 parts by weight based on 100 parts by weight of all solid contents therein.

As the protective layer, preferably a norbornene-based resin film (A) may be used. The norbornene-based resin film has a characteristic that the absolute value of a photoelastic coefficient (C[550]) is small. In the present specification “norbornene-based resin” means (co)polymer obtained by using a norbornene-based monomer having a norbornene ring as a part or the whole of a starting material (monomer). The “(co)polymer” means homopolymer or copolymer.

The C[550] of the norbornene-based resin film is preferably from 1×10⁻¹² to 20×10⁻¹² m²/N, more preferably from 1×10⁻¹² to 10×10⁻¹² m²/N. When a retardation film having the absolute value of a photoelastic coefficient in this range is used, a liquid crystal display wherein a large optical unevenness is not generated can be obtained.

As for the norbornene-based resin, a norbornene-based monomer having a norbornene ring (having double bond in norbornene ring) is used as a starting material. The norbornene-based resin may have a norbornene ring or may not have a norbornane ring as a constituent unit in a (co)polymer state. Examples of the norbornene-based resin having a norbornane ring as a constituent unit in a (co)polymer state include tetracyclo[4.4.1^{2,5}.1^{7,10}.0]deca-3-ene, 8-methyltetracyclo[4.4.1^{2,5}.1^{7,10}.0]deca-3-ene, 8-methoxycarbonyltetracyclo[4.4.1^{2,5}.1^{7,10}.0]deca-3-ene, or the like. Examples of the norbornene-based resin not having a norbornane ring as a constituent unit in a (co)polymer state include the (co)polymer obtained by using a monomer that becomes 5-membered ring as a result of cleavage. Examples of the monomer that becomes 5-membered ring as a result of cleavage include such as norbornene, dicyclopentadiene, 5-phenylnorbornene, and derivatives thereof. When the norbornene-based resin is a copolymer, an alignment condition of the molecules is not particularly limited, and it may be a random copolymer, a block copolymer or a graft copolymer.

Examples of the norbornene-based resin include a resin (a) obtained by hydrogenating a ring-opening (co)polymer made from a norbornene-based monomer, a resin (b) obtained by addition-(co)polymerizing a norbornene-based monomer or the like. The resin (a), which is obtained by hydrogenating a ring-opening (co)polymer made from a norbornene-based monomer, includes a resin obtained by hydrogenating a ring-opening copolymer made from one or more norbornene-based monomers, an α-olefin, a cycloalkene and/or a non-conjugated diene. The resin (b), which is obtained by addition-copolymerizing a norbornene-based monomer, includes a resin obtained by addition-copolymerizing one or more norbornene-based monomers, and an α-olefin, a cycloalkene and/or a non-conjugated diene.

The resin (a), which is obtained by hydrogenating a ring-opening (co)polymer made from a norbornene-based monomer, can be yielded by causing the norbornene-based monomer to react for metathesis so as to yield the ring-opening (co)polymer, and then hydrogenating the ring-opening (co)polymer. Specifically, the resin (a) may be obtained by methods described in, for example, paragraphs [0059] to [0060] in JP-A-11-116780, paragraphs [0035] to [0037] in JP-A-2001-350017, and others. The resin (b), which is obtained by addition-copolymerizing a norbornene-based monomer, can be yielded by a method described in, for example, Example 1 in JP-A-61-292601.

The weight-average molecular weight (Mw) of the norbornene-based resin is preferably from 20,000 to 500,000. The weight-average molecular weight (Mw) of the norbornene-based resin refers to a value measured by gel permeation chromatography (polystyrene standard) using a tetrahydrofuran solvent.

The glass transition temperature (Tg) of the norbornene-based resin is preferably from 120 to 170° C. The above-mentioned resin can give a film excellent in thermal stability and drawability. The glass transition temperature (Tg) is a value calculated out by DSC technique on the code of JIS K 7121.

A retardation film (A) containing the norbornene-based resin can be obtained by any appropriate shaping or working method. Preferably, the retardation film (A) containing the norbornene-based resin is formed by drawing a polymeric film shaped into a sheet form by a solvent casting or melt-extruding method. Examples of the method for drawing the polymeric film include longitudinal uniaxial drawing, transverse uniaxial drawing, longitudinal and transverse biaxial simultaneous drawing, longitudinal and transverse biaxial successive drawing, or the like. The drawing method is preferably transverse uniaxial drawing. When transverse uniaxial drawing is adopted, it is possible to form a roll of a polarizing plate wherein the slow axis direction of the retardation film (A) is perpendicular to the absorption axis direction of the polarizer (the above-mentioned polarizer, which is made of a drawn film containing iodine). As a result, the productivity of the polarizing plate can be largely improved. The temperature at which the polymeric film is drawn (drawing temperature) is preferably from 120 to 200° C. The ratio at which the polymeric film is drawn (draw ratio) is preferably more than 1 and 4 or less.

As the polymeric film containing the norbornene-based resin, a commercially available film may be used as it is. The commercially available film may be subjected to one or more secondary processing, such as drawing treatment and/or contracting treatment. Examples of the commercially available polymeric film containing the norbornene-based resin include ARTON series (trade name: ARTON F, ARTON FX, and ARTON D) manufactured by JSR Corp.; ZEONOR series (trade name: ZEONOR ZF14 and ZEONOR ZF16) manufactured by Optes Inc; or the like.

The retardation film used as the first protective layer may contain arbitrary and appropriate additives. Examples of the additives include a plasticizer, heat stabilizer, light stabilizer, lubricant, antioxidant, ultraviolet absorbers, flame retardant, colorant, antistatic agent, mutual solubilizing agent, crosslinking agent, thickener, or the like. The amount of the additives is preferably more than 0 and 10 or less parts by weight based on 100 parts by weight of the resin component contained mainly.

The second polarizing plate used in the present invention preferably comprises a second polarizer, and a second protective layer on the liquid-crystal-cell-arranged side of the second polarizer. The second protective layer is preferably adhered onto the second polarizer through an adhesive layer. In a case where the second protective layer has a slow axis, the second protective layer is adhered to make the slow axis direction of the second protective layer substantially perpendicular to the absorption axis direction of the second polarizer.

The second polarizer is not particularly limited. For example, the same film exemplified above as the first polarizer may be used as the second polarizer.

The index ellipsoid of the second protective layer preferably satisfies a relationship of nx≧ny>nz. In the present specification, “nx≧ny>nz” means the relationship of nx=ny>nz (also referred to as negative uniaxially) or the relationship of nx>ny>nz (also referred to as negative biaxially). The second protective layer having the relationship can prevent the polarizer from contracting or expanding, so as to make the mechanical strength of the polarizer high. Additionally, the protective layer may be combined with the liquid crystal cell, which has a multigap structure such as VA mode, or IPS mode. The protective layer combined with the liquid crystal cell makes it possible to yield a liquid crystal display having a high contrast ratio in oblique directions and a smaller color shift.

The second protective layer may be a single layer, or may be a laminate composed of plural layers. The thickness of the second protective layer is preferably from 20 to 200 μm. The transmittance (T₂[550]) of the second protective layer at a wavelength of 550 nm is preferably 90% or more.

When the index ellipsoid of the second protective layer satisfies the relationship of nx=ny>nz, the Re₂[550] is less than 10 nm, preferably 5 nm or less. By use of this second protective layer, a liquid crystal display having a high contrast ratio in oblique directions can be obtained.

The Rth₂[550] of the second protective layer may be appropriately set in accordance with the alignment state of the liquid crystal molecules when no voltage is applied thereto, or a purpose. The Rth₂[550] is preferably 10 nm or more, more preferably from 20 to 400 nm.

In a case where the liquid crystal layer comprises liquid crystal molecules aligned to homeotropic alignment when no voltage is applied thereto, the absolute value of the Rth₂[550] of the second protective layer is set to a value somewhat smaller than the absolute value of the retardation value in the thickness direction (Rth_{LC}[550]) of the liquid crystal layer. The Rth₂[550] of the second protective layer is preferably from 80 to 380 nm, more preferably from 150 to 300 nm.

In a case where the liquid crystal layer comprises liquid crystal molecules aligned to homogeneous alignment when no voltage is applied thereto, the Rth₂[550] of the second protective layer is preferably from 10 to 150 nm, more preferably from 20 to 100 nm. A liquid crystal display having a high contrast ratio in oblique directions can be obtained by use of the second protective layer having the Rth₂[550] in the above-mentioned range in the liquid crystal cell comprising liquid crystal molecules aligned to homogeneous alignment.

When the index ellipsoid of the second protective layer satisfies the relationship of nx>ny>nz, the same layer described above as the first protective layer may be used as the second protective layer.

As a material for forming the second protective layer, an appropriate material may be adopted. The second protective layer preferably comprises a thin film made from a solution containing a polyimide-based resin. When the polyimide-based resin is shaped into a sheet form by a solution casting method, the molecules are spontaneously aligned with ease in the step wherein the solvent vaporizes; therefore, a retardation film having a large retardation value in the thickness direction can be formed into a very thin thickness. The thin film contains the polyimide-based resin preferably in an amount of from 60 to 100 parts by weight based on 100 parts by weight of all solid contents therein.

The thickness of the thin film containing the polyimide-based resin is preferably from 0.5 to 10 μm, and more preferably from 1 to 5 μm. The birefringence index of the thin film (Δn_{xz}[550]) is preferably from 0.01 to 0.12, more preferably from 0.02 to 0.08. Such a polyimide-based resin may be obtained by, for example, a method described in U.S. Pat. No. 5,344,916.

### D. Liquid Crystal Display

The liquid crystal display of the present invention comprises the above-mentioned liquid crystal panel. FIG. 4 is a schematic sectional view of a liquid crystal display according to a preferred embodiment. It is noted that the ratio of the length, width and thickness of each constituting member shown in FIG. 4 are different from an actual one for the sake of visibility. A liquid crystal display 200 is provided with at least a liquid crystal panel 100 and a backlight unit 80 arranged on one of both sides of the liquid crystal panel 100. The illustrating examples show the case where a direct radiation system is adopted as the backlight unit. However, a sidelight system may be adopted as a substitute for the backlight unit.

When the direct radiation system is adopted, the above backlight unit 80 is preferably provided with at least a light source 81, a reflecting film 82, a diffusion plate 83, a prism sheet 84, and a luminance-improving film 85. When the sidelight system is adopted, the backlight unit is preferably further provided with, in addition to the above-mentioned structures, at least a light conductive plate and a light reflector. Here, the optical members illustrated in FIG. 4 may be partly omitted or substituted with other optical members corresponding to the application of the liquid crystal display comprising the illumination system of the liquid crystal display and drive mode of a liquid crystal cell as far as the effect of the present invention is obtained.

The liquid crystal display of the present invention may be either a transmitting type in which light is emitted from the backside of the liquid crystal panel or a reflecting type in which light is emitted from the viewing side of the liquid crystal panel. Furthermore, the liquid crystal display of the present invention may be a semi-transparent type having both the natures of the transmitting type and reflecting type.

### E. Application

The liquid crystal display of the present invention is used for arbitrary appropriate applications. Examples of the applications include office automation equipments such as a personal computer monitor, a notebook-sized personal computer, and a copying machine; portable equipments such as a portable telephone, a watch, a digital camera, a personal digital assistant (PDA), and a portable game machine; domestic electrical equipments such as a video camera, a television set, and a microwave oven; on-vehicle equipments such as a back monitor, a monitor for a car navigation system, and a car audio; display equipments such as an information monitor for a commercial store; security equipments such as an observation monitor; care/medical equipments such as a care monitor and a medical monitor; and the like.

The applications of the liquid crystal display of the present invention are preferably a television set. The screen size of the television set is preferably wide 17 type (373 mm×224 mm) or more, more preferably wide 23 type (499 mm×300 mm) or more, and particularly preferably wide 32 type (687 mm×412 mm) or more.

### EXAMPLES

The present invention will be further described bellow by way of Examples and Comparative Examples. The present invention is not limited to Examples.

### (1) Measurement of Single Transmittance of Polarizer:

Using a spectrophotometer [trade name: “DOT-3”, manufactured by Murakami Color Research Laboratory], Y value corrected by a luminosity factor was measured by the two-degree field (C light source) on the code of JIS Z 8701-1982.

### (2) Measurement of Polarization Degree of Polarizer:

Using a spectrophotometer [trade name: “DOT-3”, manufactured by Murakami Color Research Laboratory], the parallel transmittance (H₀) and orthogonal transmittance (H₉₀) of a polarizer were measured to calculate the polarization degree from the following expression: Polarization Degree (%)={(H₀−H₉₀)/(H₀+H₉₀)}^{1/2}×100. The parallel transmittance (H₀) is a value of the transmittance of a parallel type laminate polarizer produced by overlapping two of the same polarizers on each other such that the absorption axes of these polarizers are parallel to each other. Also, the above orthogonal transmittance (H₉₀) is a value of the transmittance of an orthogonal type laminate polarizer produced by overlapping two of the same polarizers on each other such that the absorption axes of these polarizers are perpendicular to each other. These transmittances are Y value corrected by a luminosity factor and measured by the two-degree field (C light source) on the code of JIS Z 8701-1982.

### (3) Method of Measuring Thickness:

When the thickness was less than 10 μm, it was measured by spectrophotometer for a thin film [trade name: “Multi Channel Photo Detector MCPD-2000”, manufactured by Otsuka Electronics Co., Ltd.]. When the thickness was 10 μm or more, it was measured by using a digital micrometer (trade name: “KC-351C Model”, manufactured by Anritsu Corporation).

### (4) Method for Measuring Retardation Values (Re[λ] and Rth[λ])), Nz Coefficient, and T[550]:

A spectroscopic ellipsometer [product name: “M-220”, manufactured by JASCO Corp.] was used to measure the retardation value at a wavelength of λ (nm) in an environment of 23° C. As the average refractive index, there was used a value measured by use of an Abbe's refractometer [product name: “DR-M4”, manufactured by Atago Co., Ltd.].

### (5) Method for Measuring Absolute Value (C[λ]) of Photoelastic Coefficient:

While a stress (5 to 15 N) was applied to a sample (size: 2 cm×10 cm) in the state that both ends thereof were sandwiched, the spectroscopic ellipsometer [product name: “M-220”, manufactured by JASCO Corp.] was used to measure the retardation value of the center of the sample at a wavelength of λ (nm) in an environment of 23° C. The C[λ] was calculated from the slope of the resultant function between the stress value and the retardation value.

### Reference Example 1

### Formation of Liquid Crystal Cell

A colored resin solution wherein a pigment was dispersed was coated onto a glass substrate on which a black matrix was formed, and the resultant was pre-baked so as to be dried, and a colored resin layer was formed. Next, a positive resist was coated onto the colored resin layer, and the resultant was exposed to light, by using a photomask. A developing solution was used to develop the positive resist, and the colored resin layer was etched. Thereafter, the positive resist was peeled off. In order to form red, green and blue filters, this operation was repeated three times to form a color filter substrate while the thicknesses of the colored resin layers in the individual colors (color filters) were made different from each other.

Next, thin film transistors, scanning lines, signal lines, and pixel electrodes were formed on another glass substrate to form an active matrix substrate. Alignment films were formed on the two substrates, respectively. The surfaces thereof were rubbed in a single direction with a rubbing cloth.

Next, spherical fine particles (spacers) were scattered onto the active matrix substrate. In the meantime, an epoxy resin adhesive was coated onto the region around an effective display area of the color filter substrate, except an opening for injection of liquid crystal, by screen printing. Thereafter, the active matrix substrate and the color filter substrate were put onto each other, and they were thermally adhered to each other while pressure was applied thereto, and thereby forming an empty cell wherein the cell gaps d_{R}, d_{G} and d_{B} corresponding to the individual color filters were 3.5 μm, 3.3 μm, and 2.95 μm, respectively.

A nematic liquid crystal having a positive dielectric constant anisotropy (Δn[550]=0.10) was injected into the empty cell by vacuum injection. After the injection, the opening for the injection of the liquid crystal was sealed with an ultraviolet curable resin to form a liquid crystal cell in an IPS mode. The Re_{LC}[650], the Re_{LC}[550], and the Re_{LC}[450] of the liquid crystal layer were 330 nm, 330 nm, and 325 nm, respectively, when no voltage was applied thereto.

### Reference Example 2

### Formation of First Polarizing Plate

A polymeric film [trade name: “VF-PS#7500”, manufactured by Kuraray Co., Ltd.], 75 μm in thickness, made mainly of a polyvinyl-alcohol-based resin was immersed in an aqueous solution containing iodine and potassium iodide (iodine concentration=0.03% by weight) while a tensile force was applied thereto in the longitudinal direction of the film. The film was drawn to make the final drawn length 6.2 times longer than the original length, and thereby forming a polarizer (a). This polarizer (a) had the following properties: thickness=25 μm, polarization degree P=99%, and single transmittance T=43.5%

Next, a tenter drawing machine was used to draw a polymeric film [trade name: “ZEONOR ZF14”, manufactured by Optes Inc.], 40 μm in thickness, containing a norbornene-based resin 1.2 times in an air-circulating constant-temperature oven of 150° C. by fixed-end transverse uniaxial drawing, and thereby forming a retardation film (a). In this retardation film (a), the index ellipsoid thereof satisfied the relationship of nx>ny>nz, and had the following properties:

Thickness=32 μm,

T[550]=90%,

Re[550]=60 nm,

Rth[550]=72 nm,

Nz coefficient=1.2,

Re[450]/Re[550]=1.0, and

C[550]=5.1×10⁻¹² m²/N.

The retardation film (a) was adhered onto a one of both sides of the polarizer (a) through an adhesive layer to make the slow axis direction of the retardation film (a) substantially perpendicular to the absorption axis direction of the polarizer (a). Next, a commercially available triacetylcellulose film was adhered onto the side of the polarizer (a) reverse to the side of the polarizer (a) provided with the retardation film (a) through an adhesive layer, and thereby forming a polarizing plate (a).

### Reference Example 3

### Formation of Second Polarizing Plate

A commercially available polarizing plate [NPF-TEG1224DU, manufactured by Nitto Denko Corp.] was used as a polarizing plate (b). In this polarizing plate (b), its polarizer had, on both sides thereof, a triacetylcellulose film (thickness: 40 μm) as a protective layer. In this triacetylcellulose film, the index ellipsoid thereof satisfied the relationship of nx=ny>nz, and the Rth[550] was 40 nm.

### Example

### Formation of Liquid Crystal Panel

The polarizing plate (a) was adhered, as a first polarizing plate, onto the side reverse to the viewing side of the liquid crystal cell formed in Reference Example 1 through a pressure-sensitive adhesive layer. The adhesion was performed to face the retardation film (a) of the polarizing plate (a) to the liquid crystal cell.

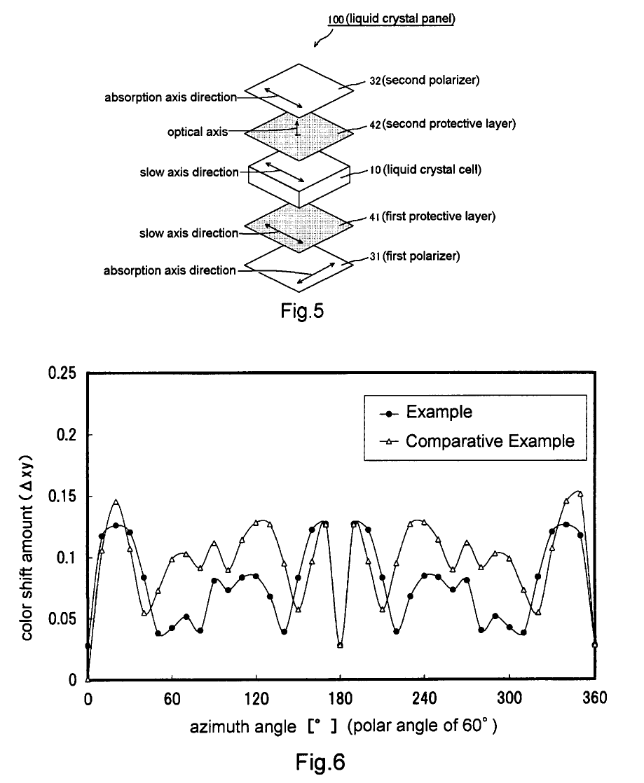

Next, the polarizing plate (b) was adhered, as a second polarizing plate, onto the viewing side of the liquid crystal cell through a pressure-sensitive adhesive layer. The thus-formed product was used as a liquid crystal panel (a). The positional relationship between the individual constituting members in this liquid crystal panel (a) was as shown in FIG. 2C. The relationship between the optical axes of the individual constituting members in the liquid crystal panel (a) was as shown in FIG. 5. FIG. 5 is a schematic perspective view of the liquid crystal panel according to Example. The absorption axis direction of the first polarizer 31 corresponding to the polarizer (a) in Reference Example 2 was substantially perpendicular to the absorption axis direction of the second polarizer 32 corresponding to the polarizer of the polarizing plate (b) in Reference Example 3. The slow axis direction of the first protective layer 41 corresponding to the retardation film (a) in Reference Example 2 was substantially perpendicular to the absorption axis direction of the first polarizer 31. The slow axis direction of the first protective layer 41 was substantially parallel to the slow axis direction of the liquid crystal cell 10 corresponding to the liquid crystal cell in Reference Example 1. The second protective layer 42 in FIG. 5 corresponded to the protective layer (triacetylcellulose film) in Reference Example 3.

### Comparative Example

A liquid crystal panel was formed in the same way as in Example described above except that each of the cell gaps d_{R}, d_{G} and d_{B} corresponding to the individual color filters were 3.3 μm, and a liquid crystal cell wherein the Re_{LC}[650], the Re_{LC}[550], and the Re_{LC}[450] were 311 nm, 330 nm, and 363 nm, respectively.

### [Evaluation]

The liquid crystal panel according to Example was united to a backlight unit to produce a liquid crystal display. In the same way, the liquid crystal panel according to Comparative Example was united to a backlight unit to produce a liquid crystal display.

In order to confirm the display characteristics of the liquid crystal displays according to Example and Comparative Example, the azimuth angle dependency of the color shift (Δxy value) at a polar angle of 60° was measured by a method described below. The results thereof are shown in a graph of FIG. 6.

### Method for Measuring Color Shift Amount (Δxy Value) of Each of Liquid Crystal Displays:

After 30 minutes elapsed from the time when the backlight was turned on in a dark room of 23° C., the measurement was made. Specifically, after the 30 minutes elapsed, a black image was displayed in the liquid crystal display, and a device (product name: EZ Contrast 160D) manufactured by ELDIM Co. was used to measure the hue, the x value and the y value on the display screen at a polar angle of 60° in overall directions (from 0 to 360°). The color shift amount (Δxy value) in oblique directions was calculated by substituting the measured values for the following expression: {(x−0.313)²+(y−0.329)²}^{1/2}.

In the expression, x=0.313 and y=0.329 represents black with no color in a case where a black image is displayed on the display screen wherein the long side direction of the liquid crystal panel is defined as an azimuth angle of 0° and the normal direction of the liquid crystal panel is defined as a polar angle of 0°.

As illustrated in FIG. 6, in the liquid crystal panel according to Example, the color shift was very small, so that excellent properties were exhibited. In the liquid crystal panel of Example, the retardation film (a) having an index ellipsoid satisfying the relationship of nx>ny>nz was used as the first protective layer; however, when a retardation film having an index ellipsoid satisfying the relationship of nx>ny=nz is used instead of this film, the same display characteristic can be obtained as well.

### INDUSTRIAL APPLICABILITY

The liquid crystal panel of the present invention can widely be used for displays in televisions, portable telephones, and the like.

1. A liquid crystal panel, comprising a liquid crystal cell, a first polarizing plate arranged on one of both sides of the liquid crystal cell, and a second polarizing plate arranged on the other side of the liquid crystal cell,
wherein the liquid crystal cell comprises red, green and blue color filters, and a liquid crystal layer,
the liquid crystal layer has a multigap structure satisfying the following relationship: d_{R}≧d_{G}>d_{B} wherein d_{R}, d_{G} and d_{B} represent the thicknesses of the liquid crystal layer which correspond to the red color filter, the green color filter, and the blue color filters, respectively,
the first polarizing plate comprises a first polarizer and a first protective layer arranged on the liquid crystal cell side of the first polarizer, and in the first protective layer, the index ellipsoid thereof satisfies the following relationship: nx>ny≧nz.

2. The liquid crystal panel according to claim 1, wherein the multigap structure is formed by making the thicknesses of the red, green and blue color filters different from each other.

3. The liquid crystal panel according to claim 1, wherein the liquid crystal layer comprises liquid crystal molecules aligned to homeotropic alignment when no voltage is applied thereto, and further the retardation value in the thickness direction (Rth_{LC}[550]) of the liquid crystal layer at a wavelength of 550 nm is larger than the retardation value in the thickness direction (Rth_{LC}[450]) of the liquid crystal layer at a wavelength of 450 nm.

4. The liquid crystal panel according to claim 1, wherein the liquid crystal layer comprises liquid crystal molecules aligned to homogeneous alignment when no voltage is applied thereto, and further the in-plane retardation value (Re_{LC}[550]) of the liquid crystal layer at a wavelength of 550 nm is larger than the in-plane retardation value (Re_{LC}[450]) of the liquid crystal layer at a wavelength of 450 nm.

5. The liquid crystal panel according to claim 1, wherein the slow axis direction of the first protective layer is substantially perpendicular to the absorption axis direction of the first polarizing plate.

6. The liquid crystal panel according to claim 1, wherein the in-plane retardation value (Re₁ [550]) of the first protective layer at a wavelength of 550 nm is from 20 to 200 nm.

7. The liquid crystal panel according to claim 1, wherein the first protective layer is a retardation film (A) containing a norbornene-based resin.

8. A liquid crystal display, comprising a liquid crystal panel according to claim 1.
